(19) United States
(12) Patent Application Publication
(10) Pub. No.: US 2026/0322938 A1
(43) Pub. Date: Oct. 15, 2026

(54) SYSTEMS AND METHODS FOR RECALLING BILLBOARDS

(71) Applicant: Ford Global Technologies, LLC, Dearborn, MI (US)

(72) Inventors: Thomas Joseph Hermann, Troy, MI (US); Keith Weston, Canton, MI (US)

(73) Assignee: Ford Global Technologies, LLC, Dearborn, MI (US)

(21) Appl. No.: 19/175,554

(22) Filed: Apr. 10, 2025

(51) Int. Cl. H04N 1/21; B60K 35/28; G01C 21/36; G06F 3/0482; G06F 3/0485; G06F 16/532; G06V 20/56

(52) U.S. Cl. CPC H04N 1/2129; B60K 35/285; G01C 21/3602; G01C 21/3697; G06F 3/0482; G06F 3/0485; G06F 16/532; G06V 20/56; B60K 2360/166; B60K 2360/186

(57) ABSTRACT

A vehicle including a sensor unit, a memory and a processor is disclosed. The sensor unit may capture a plurality of images of a plurality of information boards located on a vehicle route. The processor may obtain the plurality of images from the sensor unit and cause the memory to store the plurality of images or a first set of images from the plurality of images, based on a first user preference. The processor may fetch a second set of images from the memory based on a second user preference, and render an interface on a display screen to display the second set of images, thereby enabling a user to recall and view the second set of images associated with information boards located on the vehicle route.

### FIELD

The present disclosure relates to systems and methods for recalling billboards on a vehicle route.

### BACKGROUND

Generally, roadways are filled with various advertisements and billboards. Vehicle drivers are typically focused on the road while driving the vehicles and may not fully read the messages on the billboards, and the passengers may overlook them as well. In addition, vehicle drivers/passengers may not always retain or recall the content displayed on the billboards they passed earlier in their journey. It is therefore desirable to address shortcomings in such situations.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of a system to recall information boards in accordance with the present disclosure.

FIG. 3 depicts an example view of a user interacting with a vehicle Human-Machine Interface (HMI) to view information associated with information boards in accordance with the present disclosure.

FIG. 4 depicts an example view of an HMI displaying additional details associated with an information board in accordance with the present disclosure.

FIG. 5 depicts a flow diagram of an example method to recall information boards in accordance with the present disclosure.

### DETAILED DESCRIPTION

### Overview

The present disclosure describes a vehicle that may recall information boards placed along the roads on a vehicle route. The information boards may include billboards or signboards. The vehicle that may capture images of the information boards, via a vehicle's sensor unit (e.g., external cameras installed in the vehicle). Responsive to capturing the images, the vehicle may store the images in a vehicle memory, to enable a user to fetch or recall the images as per user preferences and view them on a vehicle Human-Machine Interface (HMI). The user may recall the images after passing through the information board(s) that the user may have missed previously in the journey, and may scroll through the images of the information boards that the user may have missed. For example, the user may recall the images when the user has just missed an information board, or any time during the journey (e.g., 15 minutes or 1 hour after passing the information board).

To facilitate the user in recalling the images of the information boards, in some aspects, the vehicle may first receive a user request to activate an information board recall mode. Responsive to obtaining the user request, the vehicle may cause the sensor unit to capture images of information boards on the vehicle route and store the captured images in the vehicle memory. Thereafter, the vehicle may enable the user to recall and view the images on the HMI. In this way, when the user desires to view the images associated with the information boards at a later stage (e.g., after passing through the information board(s)), the vehicle may facilitate the user to recall/pull and view the images on the HMI at a later stage.

In some aspects, the vehicle may store all the images associated with the information boards captured by the sensor unit in the vehicle route. In other aspects, the vehicle may store only selective (or a subset of) images in the vehicle memory based on user preferences. For instance, in this case, the vehicle may store images associated with only rest-area related information boards or restaurant related information boards, based on user preferences.

Furthermore, the vehicle may enable the user to recall the images stored in the vehicle memory based on another set of user preferences. The user may recall all the images stored in the vehicle memory or may recall a subset of images that the user is interested in viewing. For instance, based on user preferences, the vehicle may fetch images captured recently in the last 5 minutes, or images associated with information boards associated with gas stations, rest areas, restaurants, etc.

In addition to enabling the user to recall the images from the vehicle memory, the vehicle may enable the user to remove/delete one or more images from the vehicle memory or to view more details associated with a specific image/information board. For instance, the user may swipe right to remove an image fetched from the memory and displayed on HMI. The vehicle may additionally identify other images similar to the image swiped by the user, and remove these images as well from the vehicle memory. For example, when the HMI displays an image associated with a hotel billboard and the user swipes right to indicate that the user is not interested in viewing hotel-related billboard images, the vehicle removes all hotel-related billboard images from the vehicle memory.

In further aspects, the vehicle may enable the user to view additional details associated with an image if the user is interested in the displayed image and desired to view more information. In this case, the user may swipe left on an image associated with a specific information board on the HMI to view more details. For example, the user may swipe left on a restaurant-related billboard image to determine hours of operation/menus/services/other offerings for users by the restaurants, geographical location, etc. In this case, responsive to the user swiping left on the image, the vehicle may fetch additional information associated with the information board included in the image from a server, and display the additional information on the HMI. The vehicle may further facilitate the user to navigate to the location associated with the information board included in the image.

The present disclosure discloses a vehicle that facilitates the user to recall the billboards when the user may not have fully read what was written on the billboards the user has just passed, or when the user may not fully remember the billboard's content after passing it. In addition, the vehicle facilitates the user to conveniently interact with the billboard images and extract useful information. The vehicle further facilitates the user to search additional details associated with a billboard image in an external server, including hours of operation/menus / services. The vehicle further facilitates sharing of billboard images with other vehicles (e.g., to fix a meeting location) via vehicle-to-vehicle communication.

These and other advantages of the present disclosure are provided in detail herein.

### ILLUSTRATIVE EMBODIMENTS

The disclosure will be described more fully hereinafter with reference to the accompanying drawings, in which example embodiments of the disclosure are shown, and not intended to be limiting.

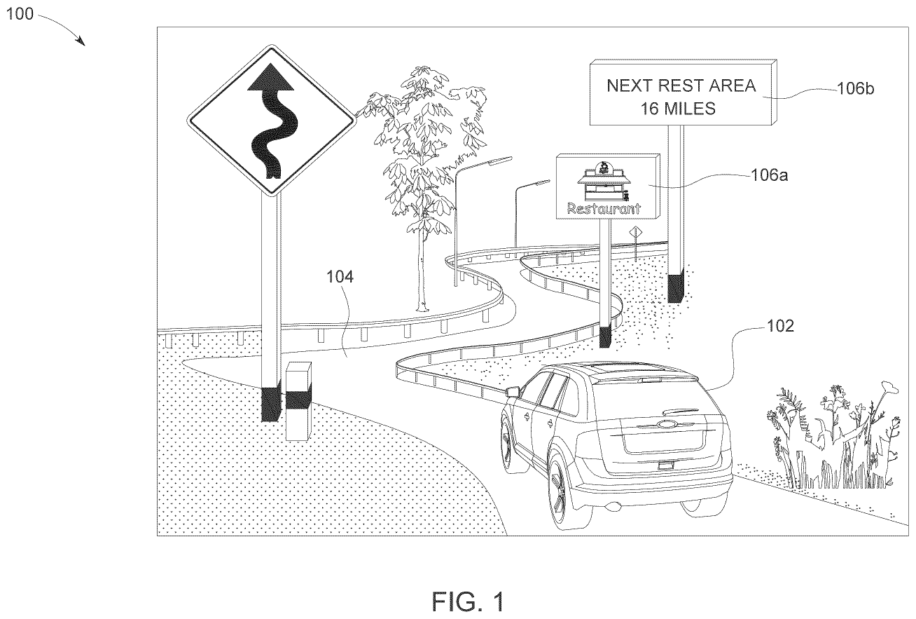

FIG. 1 depicts an example environment 100 in which techniques and structures for providing the systems and methods disclosed herein may be implemented. The environment 100 may include a vehicle 102 that may be traveling on a road network 104.

The vehicle 102 may take the form of any passenger or commercial vehicle such as a car, a work vehicle, a crossover vehicle, a truck, a van, a minivan, a taxi, a bus, etc. The vehicle 102 may be a manually driven vehicle or may be configured to operate in a partially/fully autonomous mode. Further, the vehicle 102 may include any powertrain, such as a gasoline engine, one or more electrically-actuated motor(s), or a hybrid system.

The environment 100 may further include a plurality of information boards 106a, 106b (collectively referred to as information boards 106) located along the roads on the road network 104. The information boards 106 may include billboards or signboards. The information boards 106 may be outdoor advertisements designed to capture visibility of specific brands or products, pointing out nearby restaurants, gas stations, hotels, attractions, and/or the like. The information boards 106 may further serve as an aid for the travelers, and provide helpful information as well. For example, the information boards 106 may provide information associated with next rest area/rest rooms, directional information, and/or the like.

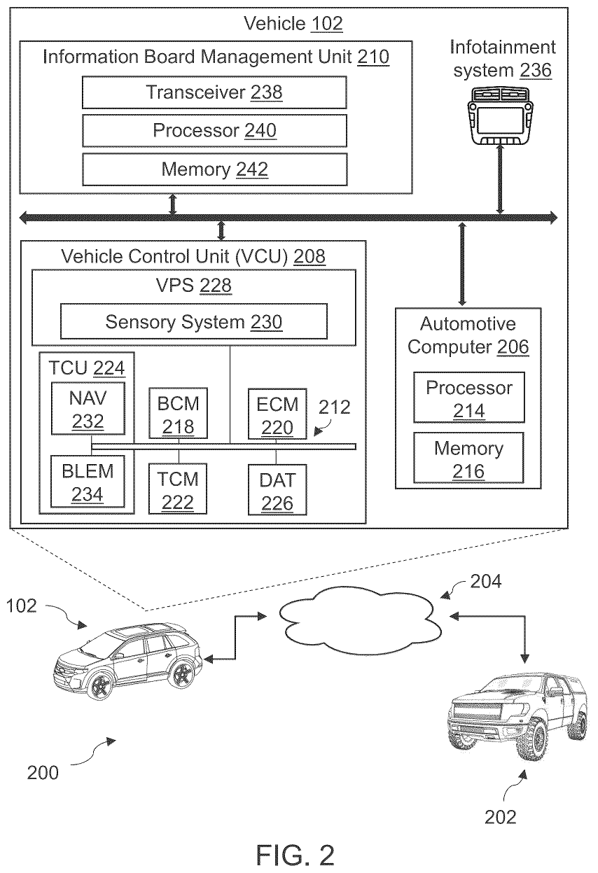

The vehicle 102 may include one or more exterior cameras (that may be part of a vehicle's sensor unit or vehicle sensory system 230 shown in FIG. 2), which may capture images of the information boards 106 located on a vehicle route (and outside the vehicle 102). In some aspects, the exterior camera(s) may be located in a vehicle's front portion.

The vehicle 102 may further include an information board management unit (shown as information board management unit 210 in FIG. 2) that may obtain the images associated with the information boards 106 captured by the exterior cameras/sensor unit in real time when the vehicle 102 travels on the vehicle route, and store the images in a vehicle memory (shown as memory 242 in FIG. 2). The information board management unit (“unit”) may further enable the user to fetch or recall the images from the vehicle memory. Responsive to fetching the images, the unit may render an interface on a display screen (or a vehicle Human-Machine Interface (HMI)) to display the recalled images.

The user may recall the images after passing through the information board(s) that the user may have missed previously in the journey, and may scroll through the images of the information boards that the user may have missed. For example, the user may recall the images when the user has just missed an information board, or any time during the journey (e.g., 15 minutes or 1 hour after passing the information board). In this manner, when the user may be focused on the road and may not have fully read what was written on the information board the user has just passed, or when the user may not fully remember the information board's content after passing it, the user may recall the images and view them on the HMI, via the unit.

To enable the operation described above, in some aspects, the unit may first receive a user request to activate an information board recall mode. Responsive to obtaining the user request, the unit may cause the sensor unit to capture the images of the information boards 106 and obtain the images from the sensor unit. Thereafter, the unit may store the images in the vehicle memory, and enable the user to recall and view the images on the HMI as per user preferences. In this manner, when the user desires to view the images associated with the information board at a later stage (e.g., after passing through the information board(s)), the unit may facilitate the user to recall/pull and view the images on the HMI.

In some aspects, responsive to obtaining the images from the sensor unit, the unit may cause the vehicle memory to store the images in the vehicle memory based on a first user preference (which may be user preference associated with image storage). In some aspects, the unit may store all the images associated with the information boards 106 captured by the sensor unit in the vehicle route, when the first user preference indicates that the user desires the unit to store all images. In other aspects, the unit may store only selective (or a subset of) images in the vehicle memory when the first user preference indicates that the user desires the unit to store only selective images. For example, in the former case, the unit may store images of all the information boards 106 located in the entire vehicle journey/route. On the other hand, in the latter case, the unit may store images of information boards 106 over a predetermined time duration (e.g., images of billboards located in the last 15 minutes of the vehicle's journey/route), or information boards 106 associated with a specific place such as gas stations/rest areas / restaurants, etc., as indicated in the first user preference.

In addition, responsive to storing the images in the vehicle memory as described above, the unit may fetch/recall all the images or a subset of images from the vehicle memory based on a second user preference (which may be user preference associated with image recall from the memory). In some aspects, the unit may fetch/recall all the images stored in the vehicle memory when the second user preference indicates that the user desires to view all the stored images. In other aspects, the unit may fetch/recall only selective images from the vehicle memory when the second user preference indicates that the user desires to view only selective images. For instance, in this case, the unit may fetch images captured recently in the last 5 minutes, or images associated with information boards 106 associated with gas stations/rest areas/restaurants, etc., or fetch locations in a forward direction in the vehicle route and not in backward direction, based on the second user preference.

Further vehicle details are described below in conjunction with FIG. 2.

The vehicle 102 implements and/or performs operations, as described here in the present disclosure, in accordance with the owner manual and safety guidelines. In addition, any action taken by the user based on the notifications provided by the vehicle 102 should comply with all the rules specific to the location and operation of the vehicle 102 (e.g., Federal, state, country, city, etc.). The notifications, as provided by the vehicle 102, should be treated as suggestions and only followed according to any rules specific to the location and operation of the vehicle 102.

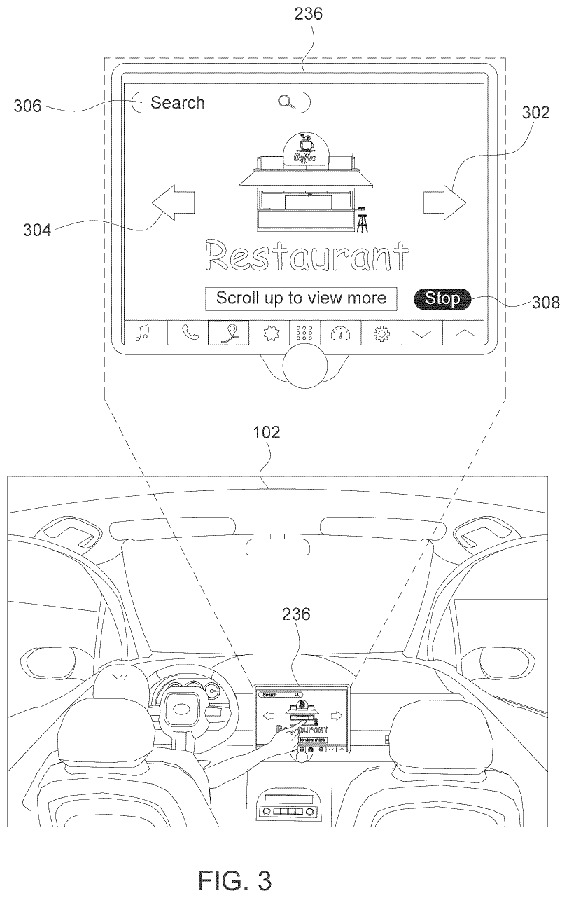

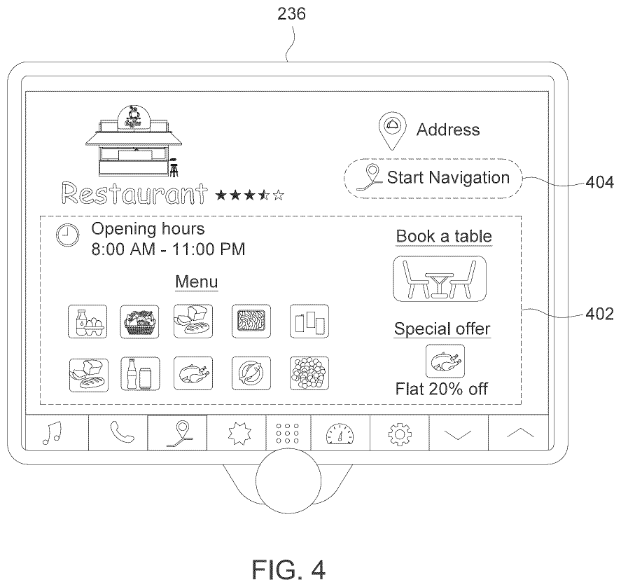

FIG. 2 depicts a block diagram of a system 200 to recall information boards in accordance with the present disclosure. While describing FIG. 2, references will be made to FIGS. 3 and 4.

The system 200 may include the vehicle 102 (or a “first vehicle”) and a second vehicle 202 that may be communicatively coupled with each other via one or more networks 204.

The network(s) 204 illustrates an example communication infrastructure in which the connected devices discussed in various embodiments of this disclosure may communicate. The network(s) 204 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 102 may include a plurality of units including, but not limited to, an automotive computer 206, a Vehicle Control Unit (VCU) 208 and an information board management unit 210 (or unit 210). The VCU 208 may include a plurality of Electronic Control Units (ECUs) 212 in communication with the automotive computer 206.

In some aspects, the automotive computer 206 and/or the unit 210 may be installed anywhere in the vehicle 102, in accordance with the disclosure. Further, the automotive computer 206 may operate as a functional part of the unit 210. The automotive computer 206 may be or include an electronic vehicle controller, having one or more processor(s) 214 and a memory 216. Moreover, the unit 210 may be separate from the automotive computer 206 (as shown in FIG. 2) or may be integrated as part of the automotive computer 206.

The processor(s) 214 may be in communication with one or more memory devices in communication with the respective computing systems (e.g., the memory 216 and/or one or more external databases not shown in FIG. 2). The processor(s) 214 may utilize the memory 216 to store programs in code and/or to store data for performing aspects in accordance with the disclosure. The memory 216 may be a non-transitory computer-readable medium or memory storing an information board management program code. The memory 216 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 208 may share a power bus with the automotive computer 206 and may be configured and/or programmed to coordinate the data between vehicle 102 systems, connected servers (not shown), and other vehicles (e.g., the second vehicle 202) operating as part of a vehicle fleet. The VCU 208 may include or communicate with any combination of the ECUs 212, such as a Body Control Module (BCM) 218, an Engine Control Module (ECM) 220, a Transmission Control Module (TCM) 222, a Telematics Control Unit (TCU) 224, a Driver Assistances Technologies (DAT) controller 226, etc.

The VCU 208 may further include and/or communicate with a Vehicle Perception System (VPS) 228, having connectivity with and/or control of one or more vehicle sensory system(s) 230 (or a “sensor unit”). The vehicle sensory system 230 may include one or more vehicle sensors including, but not limited to, a radio detection and ranging (radar) sensor configured for detection and localization of objects inside and outside the vehicle 102 using radio waves, sitting area buckle sensors, sitting area sensors, a light detecting and ranging (lidar) sensor, door sensors, proximity sensors, temperature sensors, wheel sensors, ambient weather sensors, ambient light sensors, vehicle interior and exterior cameras, one or more rain sensors, a humidity sensor, a tire pressure sensor, ultrasonic sensors, etc.

The vehicle sensory system 230 (e.g., the external cameras) may capture a plurality of images of the plurality of information boards 106 located on a vehicle route. In some aspects, the camera may further capture metadata associated with the image of the information boards 106. For example, the camera may capture date and time at which the image is taken. In addition, the camera may capture and embed latitude and longitude information into the image file, to indicate the location at which the image is taken (e.g., when the camera has a GPS module).

In some aspects, the VCU 208 may control vehicle operational aspects and implement one or more instruction sets received from a user device associated with a vehicle user, from one or more instruction sets stored in the memory 216, including instructions operational as part of the unit 210.

The TCU 224 may provide vehicle connectivity to wireless computing systems onboard and off board the vehicle 102 and may include a Navigation (NAV) receiver 232 for receiving and processing a GPS signal, a BLE Module (BLEM) 234, a Wi-Fi transceiver, a UWB transceiver, and/or other wireless transceivers (not shown in FIG. 2) that may be configurable for wireless communication (including cellular communication) between the vehicle 102 and other systems (e.g., a user device, a key fob, an NFC device, etc.), computers, and modules. The NAV receiver 232 may be configured to determine a real-time vehicle geolocation. The TCU 224 may be in communication with the ECUs 212 by way of a bus.

The ECUs 212 may control aspects of vehicle operation and communication using inputs from human drivers, inputs from an autonomous vehicle controller, the unit 210, and/or via wireless signal inputs received via the wireless connection(s) from other connected devices, such as the user device associated with the vehicle user, the server(s), among others.

The BCM 218 generally includes integration of sensors, vehicle performance indicators, and variable reactors associated with vehicle systems and may include processor-based power distribution circuitry that can control functions associated with the vehicle body such as lights, windows, security, camera(s), fan, headlights, audio system(s), speakers, wipers, door locks and access control, mirrors, various comfort controls, enclosures, and/or the like. The BCM 218 may also operate as a gateway for bus and network interfaces to interact with remote ECUs (not shown in FIG. 2).

The DAT controller 226 may provide Level-1 through Level-3 automated driving and driver assistance functionality that may include, for example, active parking assistance, vehicle backup assistance, and adaptive cruise control, among other features. The DAT controller 226 may also provide aspects of user and environmental inputs usable for user authentication.

In some aspects, the automotive computer 206 may connect with an infotainment system 236 (or a vehicle Human-Machine Interface (HMI) 236). The infotainment system 236 may include a touchscreen interface portion and may include voice recognition features, biometric identification capabilities that can identify users based on facial recognition, voice recognition, fingerprint identification, or other biological identification means. In other aspects, the HMI 236 may further receive user instructions/inputs via the touchscreen interface portion and/or display notifications/recommendations, navigation maps, etc. on the touchscreen interface portion. The HMI 236 enables the user to view the images associated with the information boards 106 and interact with the images.

The computing system architecture of the automotive computer 206, the VCU 208, and/or the unit 210 may omit certain computing modules. It should be readily understood that the computing environment depicted in FIG. 2 is an example of a possible implementation according to the present disclosure, and thus, it should not be considered limiting or exclusive.

In accordance with some aspects, the unit 210 may be integrated with and/or executed as part of the ECUs 212. The unit 210, regardless of whether it is integrated with the automotive computer 206 or the ECUs 212, or whether it operates as an independent computing system in the vehicle 102, may include a transceiver 238, a processor 240 and a computer-readable memory 242.

The transceiver 238 may receive information/inputs from one or more external devices or systems, e.g., the second vehicle 202, the server(s), and/or the like via the network 204. For example, the transceiver 238 may transmit or receive the images associated with the information boards 106 to/from the second vehicle 202, via the network 204 (e.g., via vehicle-to-vehicle (V2V) communication). Further, the transceiver 238 may transmit notifications/data / signals to the external devices or systems. In addition, the transceiver 238 may receive information/inputs from vehicle 102 components such as the infotainment system 236, the vehicle sensory system 230, the VCU 208, and/or the like. Further, the transceiver 238 may transmit notifications/command signals to the vehicle 102 components such as the VCU 208, the infotainment system 236, the BCM 218, etc.

The processor 240 and the memory 242 may be the same as or similar to the processor 214 and the memory 216, respectively. In some aspects, the processor 240 may utilize the memory 242 to store programs in code and/or to store data for performing aspects in accordance with the disclosure. The memory 242 may be a non-transitory computer-readable medium or memory storing the information board management program code. In some aspects, the memory 242 may store the images captured by the vehicle sensory system 230 (e.g., the external camera(s)). In addition, the memory 242 may store user preferences associated with image storage and recall, and other user preferences/information.

In operation, when the user desires to recall images associated with the information boards 106 (e.g., billboards), the user may transmit a request to the processor 240 to activate an information board recall mode. The user may transmit the request to activate the information board recall mode via the HMI 236 (e.g., the user may click on an “enable” button on the HMI 236 to activate the information board recall mode), via a user gesture, or via a voice command. The processor 240 may receive the request and may activate the information board recall mode.

Responsive to activating the information board recall mode, the processor 240 may cause the sensor unit (or the vehicle sensory system 230) to capture the images associated with the information boards 106 and begin to obtain the captured images from the sensor unit. The processor 240 may further cause the memory 242 to store the images, responsive to obtaining the images from the sensor unit. The processor 240 may cause the memory 242 to store images based on a first user preference (e.g., a user-defined image storage criteria that may be stored in the memory 242). The processor 240 may cause the memory 242 to store all the images (or a plurality of images) captured by the sensor unit or a first set of images of all the images captured by the sensor unit based on the first user preference. For example, the processor 240 may store images of all the information boards 106 located in the entire vehicle journey/route, or images associated with the information boards 106 located in the last 15 minutes of vehicle journey/route or information boards 106 associated with gas stations/rest areas/restaurants, etc., based on the first user preference.

In some aspects, the processor 240 may select the first set of images from all the images based on the first user preference, and may store the first set of images responsive to the selection. For instance, the user may provide a user preference to only store images associated with information boards that include information about rest areas. The processor 240 may obtain such a user preference and perform image processing on the images captured by the sensor unit (e.g., extract content associated with the images via Optical Character Recognition (OCR)). The processor 240 may then analyze the content associated with the images and select only those images for storage in which the target information (e.g., the rest area information) is present. Responsive to the selection, the processor 240 may store the selected images as the first set of images in the memory 242. In some aspects, the user may dynamically update the first user preference on the journey, and the processor 240 may accordingly store the images based on the updated first user preference.

In some aspects, the processor 244 may store the images along with their metadata (e.g., time and locations at which the images are captured). In some aspects, the processor 244 may obtain the metadata from the sensor unit, and store the metadata in the memory 242. Alternatively, the processor 244 may itself add metadata to all the images and store the metadata (along with the images) in the memory 242.

When the user desires to recall and view the images stored in the memory 242 (e.g., to view information associated with one or more information boards 106, after passing through them), the user may request the processor 244 to fetch the images from the memory 242 (e.g., via the HMI 236). The processor 240 may obtain a trigger signal when the user requests the processor 244 to fetch the images from the memory 242. In some aspects, the processor 240 may obtain the trigger signal via a user input on the display screen (e.g., the HMI 236), a user gesture, a voice command, and/or the like. Responsive to obtaining the trigger signal, the processor 240 may fetch the images from the memory 242.

In some aspects, the processor 244 may fetch or recall the images from the memory 242 based on a second user preference. The processor 244 may fetch all the images stored in the memory 242 or a second set of images (from all the images stored in the memory 242) based on the second user preference. For instance, the processor 240 may fetch only those images that are captured recently in the last 5 minutes, or the images of the information boards 106 that are associated with gas stations/rest areas/restaurants, etc., based on the second user preference. In some aspects, the second set of images may be equivalent to all the images stored in the memory 242. Alternatively, the second set of images may be a subset of all the images stored in the memory 242. Stated another way, the second set of images may be at least a subset of all the images stored in the memory 242.

In some aspects, the processor 240 may select the second set of images from all the images stored in the memory 242 based on the second user preference, and fetch the second set of images from the memory 242 responsive to the selection. In an exemplary aspect, to fetch the images captured in the last 5 minutes, the processor 244 may use the stored metadata and fetch the images captured in the last 5 minutes based on the metadata. To fetch images of the information boards 106 associated with gas stations/rest areas/restaurants, etc., the processor 244 may extract content of images via OCR, perform image processing as described above, and then fetch the images associated with the target information (e.g., images of gas stations/rest areas/restaurants, etc.) based on the image processing.

In some aspects, the second set of images may be the same as the first set of images described above. In addition, the first user preference may be the same as the second user preference. For instance, the user may prefer to store and fetch only those images that are associated with restaurants billboards. In such scenarios, the processor 244 may selectively store restaurants-related billboard images in the memory 242 after image processing, and may fetch all the restaurants-related billboard images from the memory 242 when the user desires to view them. Alternatively, the second set of images may be a subset of the first set of images, and the first user preference may be different from the second user preference. For example, the user may prefer to store only those images that are associated with all restaurant's billboards, but may desire to fetch or recall only those images that are associated with a specific restaurant “A”. Stated another way, the second set of images may be at least a subset of the first set of images.

Responsive to fetching the second set of images from the memory 242, the processor 240 may render an interface on the HMI 236 (or the display screen) to display the second set of images, as shown in FIG. 3. In some aspects, the HMI 236 may display one image at a time (along with their respective metadata) and the user may swipe/scroll up to view the other images, as shown in FIG. 3. Stated another way, the processor 240 may enable the user to scroll through the second set of images on the interface, responsive to rendering the interface. In other aspects, the HMI 236 may display multiple images (e.g., 2-3 images) at a time, and the user may swipe/scroll up to view the other images. In some aspects, the processor 240 may perform image processing, tag/categorize the images, and may display the second set of images in a group. For example, all the images associated with restaurant-related information boards may be presented as group “A”, all the images associated with rest area related information boards may be presented as group “B”, and/or the like. The user may click on any group to view information boards associated with that group. In further aspects, the processor 240 may sort the second set of images according to user's preference. In further aspects, the processor 240 may obtain interests/preferences associated with other vehicle occupants (e.g., from the memory 242 and/or from the HMI 236) and may sort the second set of images based on the interests/preferences associated with other vehicle occupants. In further aspects, the processor 240 may store and fetch information board images to/from the memory 242 based on the interests/preferences associated with other vehicle occupants. For instance, if kids want to eat food at a specific restaurant (determined from the interests/preferences associated with the other vehicle occupants), the processor 240 may store, fetch, and display images/other details associated with the specific restaurant. In this manner, the processor 240 may store and fetch targeted information board images.

In addition to enabling the user to scroll through the second set of images on the interface, the processor 240 may enable the user to remove/delete one or more images from the memory 242 or view more details associated with a specific information board. To enable this function, the processor 240 may obtain a first user input to discard/remove a first image from the second set of images, responsive to rendering the interface. For example, the user may swipe right (as indicated by an arrow 302 in FIG. 3) to remove the first image displayed on the interface. Responsive to obtaining the first user input, the processor 240 may remove the first image from the memory 242 based on the first user input. In further aspects, responsive to obtaining the first user input, the processor 240 may determine other images similar to the first image from the second set of images, and remove the first image and the other images from the memory 242 based on the first user input. For instance, when the interface displays an image associated with a hotel billboard and the user swipes right to indicate that the user is not interested in viewing hotel-related billboard images, the processor 240 may remove all the hotel-related billboard images from the memory 242.

In further aspects, the processor 240 may obtain a second user input to “accept” a second image from the second set of images, responsive to rendering the interface. In some aspects, the act of “accepting” an image may mean that the user desires to view more information or details about the information board shown in the image. Stated another way, the processor 240 may obtain the second user input to output details associated with the second image. Responsive to obtaining the second user input, the processor 244 may perform a predefined action based on the second user input. In an exemplary aspect, the user may swipe left (as indicated by an arrow 304 in FIG. 3) on the second image associated with a specific information board to view more details about the information board. For example, the user may swipe left on an image associated with a restaurant-related billboard image to determine hours of operation/menus/services/other offerings for users by the restaurant, its geographical location, etc.

Responsive to obtaining the second user request, the processor 244 may read/analyze content associated with the second image responsive to obtaining the second user request (e.g., via OCR), obtain details associated with the second image from a server based on the analyzed content, and then output the details on the interface, as shown in a view 402 of FIG. 4. In further aspects, the processor 240 may output a notification (e.g., a verbal notification) when the vehicle 102 is in proximity to the geographical location of a place associated with the information board shown in the second image. In further aspects, the processor 240 may display a navigation button 404 of the HMI 236 when the user swipes left on the second image. The user may click on the navigation button 404 to reach the place's location. The processor 240 may provide/output directions which may enable the user to navigate the vehicle 102 to the place's location, when the user clicks on the navigation button 404.

In further aspects, the interface/HMI 236 may display a search interface 306 (at the HMI's top portion, as shown in FIG. 3) when the processor 240 renders the interface to display the second set of images. The search interface 306 may enable the user to search for a specific type of information board image within the second set of images. For example, the user may search for images associated with rest area or restroom information boards via the search interface 306. As another example, the user may search for gas station locations only in the forward direction of the vehicle route and not in the backward direction, via the search interface 306. As yet another example, the user may search for a specific information board having a particular content. For example, the user may search for “restaurant A” or may search for any restaurant having opening hours after 10 PM.

The processor 240 may additionally render a chat window on the interface to enable the user to chat and extract specific information from the second set of images. For instance, the user may use the chat window to ask questions such as “where is the next rest area?”, “does this restaurant provide vegan food”, etc. The processor 240 may obtain the question, perform image analysis on the stored images and output answers. For example, to answer the question “where is the next rest area?”, the processor 240 may identify the last rest area related billboard image in the stored images, check the number of miles written on the billboard, determine how far the vehicle 102 has traveled after passing the billboard, and estimate the next rest area location and output the answer accordingly. In addition, the processor 240 may output a notification (e.g., a verbal notification) when the vehicle 102 is in proximity to the next rest area. In some aspects, the processor 240 may allow only the passengers in the vehicle 102 to recall the second set of images or extract specific information from the second set of images (or perform any other operation associated with the plurality of images), via the processor 240, and may not allow the driver to perform such operations to enable the driver to focus on the road while driving the vehicle 102.

In further aspects, the processor 240 may read/analyze content associated with the images of the billboard (e.g., the second set of images), convert the content associated with the images into audible format, and output the content in the audible format for user's reference.

In further aspects, the interface may display a stop button 308 (at the HMI's bottom portion, as shown in FIG. 3) when the processor 240 renders the interface to display the second set of images. The processor 240 may obtain a command signal from the user to stop rendering the interface via the stop button 308 and cause the HMI 236 to stop rendering the interface responsive to obtaining the command signal. In this manner, the processor 240 may render the interface when the user desires to view the second set of images and may stop rendering the interface when the user may not want to view more images. In further aspects, the processor 240 may stop the rendering the interface via a user's gesture, or via voice command.

In further aspects, the processor 240 may cause the memory 242 to store the second set of images (captured during a vehicle trip) and may remove or delete the second set of images from the memory 242 after the completion of the vehicle trip. Alternatively, the processor 240 may cause the memory 242 to store the second set of images even after the completion of the vehicle trip and may use the second set of images for the future trips (e.g., for the return journey). The processor 240 may delete the second set of images based on user's preference.

In further aspects, the processor 240 may facilitate image sharing with other vehicles, via the transceiver 238 and the network 204. For instance, when the vehicle 102 and the second vehicle 202 may be traveling in a group (e.g., along with other vehicles), the vehicles 102 and 202 may exchange information board images with each other to fix a meeting/gathering location. In some respects, the processor 240 may obtain a user selection of a third image from the second set of images, responsive to rendering the interface. The users associated with the vehicle 102 and the second vehicle 202 may use the swipe left and right feature to select the third image to decide a common location for meetup. The users may further use the chat window to interact with each other to select the common location. The processor 240 may further obtain a user request to share the third image with the second vehicle 202. Responsive to obtaining the user request, the processor 240 may transmit the third image with the second vehicle 202 via vehicle-to-vehicle communication, so that the user of the second vehicle 202 may view the fixed meeting/gathering location.

In further aspects, the processor 240 may facilitate exchange of stored images between the vehicle 102 and the second vehicle 202. For example, the processor 240 may share the images stored in the memory 242 with the second vehicle 202 via V2V communication so that the second vehicle 202 is well prepared to travel on the vehicle route on which the vehicle 102 has traveled in the past (e.g., 1 week ago).

The processor 240 may further facilitate sharing of the images with a server (e.g., via V2X communication), via the transceiver 238 and the network 204. In this case, the server may store the second set of images obtained from the vehicle 102. The user may access the server via a user device later, based on user's requirements. The user device and the server may enable the user to perform all the operations described above.

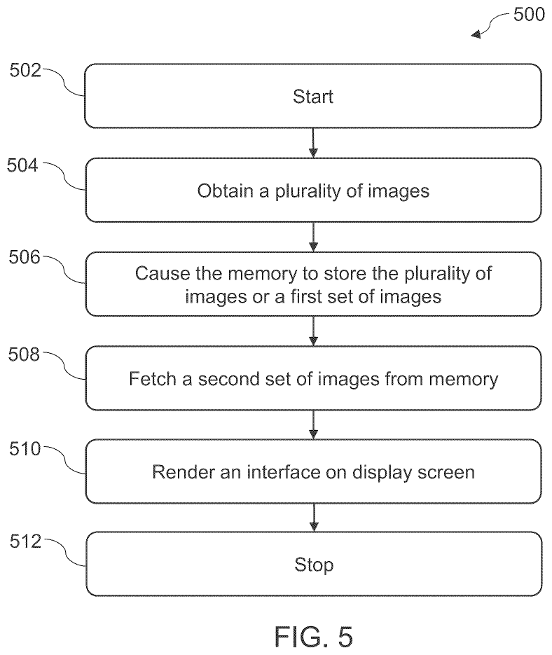

FIG. 5 depicts a flow diagram of an example method 500 to recall information boards in accordance with the present disclosure. FIG. 5 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 500 starts at step 502. At step 504, the method 500 may include obtaining, by the processor 240, a plurality of images associated with the information boards 106 from the sensor unit (or the vehicle sensory system 230). At step 506, the method 500 may include causing, by the processor 240, the memory 242 to store the plurality of images or the first set of images from the plurality of images, based on the first user preference.

At step 508, the method 500 may include fetching, by the processor 240, the second set of images from the memory 242 based on the second user preference. The second set of images may be at least a subset of the first set of images, or the second set of images may be at least a subset of the plurality of images. At step 510, the method 500 may include rendering, by the processor 240, the interface on the display screen (e.g., the HMI 236) to display the second set of images.

At step 512, the method 500 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A vehicle comprising:
a sensor unit configured to capture a plurality of images of a plurality of information boards located on a vehicle route;
a memory; and
a processor configured to:
obtain a user request to activate an information board recall mode;
responsive to obtaining the user request, cause the sensor unit to capture the plurality of images of the plurality of information boards located on the vehicle route, and obtain the plurality of images from the sensor unit in real-time, when the vehicle travels on the vehicle route;
cause the memory to store the plurality of images or a first set of images from the plurality of images, based on a first user preference;
fetch a second set of images from the memory based on a second user preference, wherein the second user preference is different from the first user preference; and
render an interface on a display screen to display the second set of images, thereby enabling a user to recall and view the second set of images associated with information boards located on the vehicle route.

2. The vehicle of claim 1, wherein the processor is further configured to select the first set of images, from the plurality of images, to store in the memory based on the first user preference.

3. The vehicle of claim 1, wherein the first user preference comprises: a preference to store images associated with a specific place or a preference to store images over a predetermined time duration of vehicle's journey, and wherein the specific place comprises at least one of: a restaurant, a coffee shop, a hotel, gas station, or rest area.

4. (canceled)

5. The vehicle of claim 1, wherein the processor is further configured to enable a user to scroll through the second set of images on the interface responsive to rendering the interface.

6. The vehicle of claim 1, wherein the processor is further configured to:
obtain a trigger signal from a user via at least one of: a user input on the display screen, a user gesture, or a voice command; and
fetch the second set of images from the memory responsive to obtaining the trigger signal.

7. The vehicle of claim 1, wherein the processor is further configured to:
obtain a first user input to remove a first image from the second set of images, responsive to rendering the interface;
determine other images similar to the first image from the second set of images; and
remove the first image and the other images from the memory based on the first user input.

8. The vehicle of claim 1, wherein the processor is further configured to:
obtain a second user input to output details associated with a second image from the second set of images, responsive to rendering the interface, wherein the details comprise at least one of: hours of operation, offerings, or services associated with a place associated with the second image; and
perform a predefined action based on the second user input.

9. The vehicle of claim 8, wherein to perform the predefined action, the processor:
analyzes content associated with the second image responsive to obtaining the second user input;
obtains the details associated with the second image from a server based on the content; and
outputs the details on the interface.

10. The vehicle of claim 8, wherein to perform the predefined action, the processor outputs directions to enable a vehicle operator to navigate the vehicle to a geographical location indicated in or associated with the second image.

11. The vehicle of claim 1, wherein the processor is further configured to:
analyze content associated with the second set of images;
convert the content associated with the second set of images into audible format; and
output the content associated with the second set of images in the audible format.

12. The vehicle of claim 1, wherein the processor is further configured to:
obtain a command signal from a user to stop rendering the interface; and
cause the display screen to stop rendering responsive to obtaining the command signal.

13. The vehicle of claim 1, wherein the processor is further configured to:
obtain a user selection of a third image from the second set of images, responsive to rendering the interface;
obtain a user request to share the third image with a second vehicle; and
transmit the third image to the second vehicle via vehicle-to-vehicle communication, responsive to obtaining the user request.

14. The vehicle of claim 1, wherein the plurality of information boards comprises billboards or signboards.

15. The vehicle of claim 1, wherein the processor is further configured to render a search interface on the display screen to enable a user to search for a specific type of images from the second set of images.

16. The vehicle of claim 1, wherein the second set of images is at least a subset of the first set of images, or the second set of images is at least a subset of the plurality of images.

17. A method comprising:
obtaining, by the processor, a user request to activate an information board recall mode;
responsive to obtaining the user request, causing, by a processor, a sensor unit of a vehicle to capture the plurality of images of the plurality of information boards located on a vehicle route, and obtaining the plurality of images from the sensor unit in real-time, when the vehicle travels on the vehicle route;
causing, by the processor, a memory of the vehicle to store the plurality of images or a first set of images from the plurality of images, based on a first user preference;
fetching, by the processor, a second set of images from the memory based on a second user preference, wherein the second user preference is different from the first user preference; and
rendering, by the processor, an interface on a display screen to display the second set of images, thereby enabling a user to recall and view the second set of images associated with information boards located on the vehicle route.

18. The method of claim 17 further comprising:
obtaining a first user input to remove a first image from the second set of images, responsive to rendering the interface;
determining other images similar to the first image from the second set of images; and
removing the first image and the other images from the memory based on the first user input.

19. The method of claim 17 further comprising:
obtaining a second user input to output details associated with a second image from the second set of images, responsive to rendering the interface; and
performing a predefined action based on the second user input, wherein performing the predefined action comprises obtaining details associated with the second image from a server, and outputting the details on the interface.

20. A non-transitory computer-readable storage medium having instructions stored thereupon which, when executed by a processor, cause the processor to:
obtain a user request to activate an information board recall mode;
responsive to obtaining the user request, cause a sensor unit of a vehicle to capture the plurality of images of the plurality of information boards located on a vehicle route, and obtain the plurality of images from the sensor unit in real-time, when the vehicle travels on the vehicle route;
cause a memory of the vehicle to store the plurality of images or a first set of images from the plurality of images, based on a first user preference;
fetch a second set of images from the memory based on a second user preference, wherein the second user preference is different from the first user preference; and
render an interface on a display screen to display the second set of images, thereby enabling a user to recall and view the second set of images associated with information boards located on the vehicle route.

21. The vehicle of claim 1, wherein the processor is further configured to:
render a chat window on the interface;
obtain a question from a user via the chat window;
perform image analysis on the second set of images based on the question; and
output an answer to the question based on the image analysis.
